(19) United States
(12) Patent Application Publication
(10) Pub. No.: US 2025/0365250 A1
(43) Pub. Date: Nov. 27, 2025

(54) WORKLOAD AWARE PACKET STEERING

(71) Applicant: MELLANOX TECHNOLOGIES, LTD., Yokneam (IL)

(72) Inventors: Parav Kanaiyalal Pandit, Bangalore (IN); Lijun Yu, Shanghai (CN); Spike Du, Shanghai (CN)

(21) Appl. No.: 18/741,148

(22) Filed: Jun. 12, 2024

(30) Foreign Application Priority Data
May 27, 2024 (WO) PCT/CN2024/095620

(51) Int. Cl. H04L 47/629; H04L 47/193; H04L 47/2483

(52) U.S. Cl. CPC H04L 47/629; H04L 47/193; H04L 47/2483

(57) ABSTRACT

Systems and methods herein are for network communications, where at least one processor can include or be associated with a data path module and a packet steering module, where the data path module can receive communications that may be associated with different communication protocols and can determine an elephant flow based in part on a size indication associated with the communications, and where the packet steering module can receive information that may be associated with the elephant flow and can enforce at least one rule to steer incoming packets for different receive queues associated with respective ones of the communication protocols.

### CROSS-REFERENCE TO RELATED APPLICATIONS

This application is related to and claims the benefit of priority to PCT Application Serial No. PCT/CN2024/095620, filed May 27, 2024, and entitled “WORKLOAD AWARE PACKET STEERING,” which is incorporated by reference herein in its entirety and for all intents and purposes.

### TECHNICAL FIELD

At least one embodiment pertains to network communications based on workload in a computing environment.

### BACKGROUND

Network communications may include a communication flow which may be associated with transmitting packets of a central processing unit (CPU) or associated CPU core that is executing an application. Further, such a CPU or CPU core, used interchangeably herein, may also be associated with incoming packets. The incoming packets belonging a communication flow may be handled by a receive side scaling (RSS) logic and may not be received by the same CPU as the one that handled the transmission side for the same communication flow. As a result, transmitting and receiving may progress with lower performance on different CPUs. In one example, Virtio® is an interface standard from the Oasis® Open Standard Body. A Virtio-enabled network device may be unable to scale up to 800 Gbps of bidirectional bandwidth, as a result of the lower performance described herein. The RSS logic handling of a communication flow may be referred to as steering. An offloading of the steering may be performed under a protocol for certain operating systems, such as, Linux®. However, such offloading may require code offloading that is also subject to performance limitations.

### BRIEF DESCRIPTION OF DRAWINGS

FIG. 1 is an illustration of a system for workload aware packet steering by offloading to a processing sub-system of a data processing unit (DPU), in at least one embodiment;

FIG. 2 is an illustration of further system details of a system for workload aware packet steering by offloading to a DPU, in at least one embodiment;

FIG. 3 is an illustration of further system details associated with rules to override receive side scaling (RSS) logic associated with workload aware packet steering by offloading to a DPU, in at least one embodiment;

FIG. 4 illustrates computer and processor aspects of a system for workload aware packet steering by offloading to a DPU, in at least one embodiment;

FIG. 5 illustrates a process flow for a system for workload aware packet steering by offloading to a DPU, in at least one embodiment;

FIG. 6 illustrates yet another process flow for a system for workload aware packet steering by offloading to a DPU, in at least one embodiment;

FIG. 7 illustrates a further process flow for a system for workload aware packet steering by offloading to a DPU, in at least one embodiment; and

FIG. 8 illustrates an exemplary data center and associated aspects to be used with a system for workload aware packet steering by offloading to a DPU, in accordance with at least one embodiment.

### DETAILED DESCRIPTION

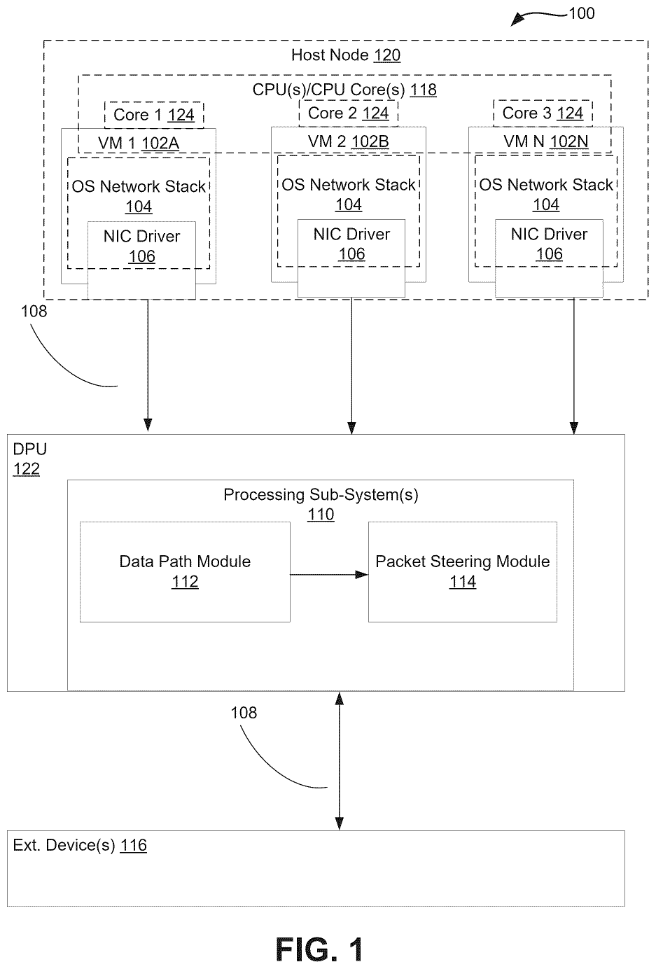

FIG. 1 is an illustration of a system 100 for workload aware packet steering by offloading to a processing sub-system of a data processing unit (DPU), in at least one embodiment. In one example, the system 100 may include at least one processor that may be part of one or more processor sub-systems 110 of a DPU 122 for network communications to address elephant flows in the network communications. The at least one processor may include or be associated with a data path module to receive the communications associated with a plurality of communication protocols and to determine an elephant flow in the communications based in part on a size indication associated with the communications. The at least one processor can further include or be associated with a packet steering module to receive information associated with the elephant flow. The at least one processor can enforce at least one rule to steer incoming packets for different receive queues associated with respective ones of the plurality of communication protocols.

As such, the system 100 herein can be used with Virtio standard input-output interfaces (vIO IFs), including for legacy vIO IFs that may be legacy Virtio® based devices from the Oasis® Open Standard Body. As used herein, the offloading allows for a kernel bypass to be performed with respect to packet steering that can be handled by the DPU 122 instead of a CPU(s) or CPU core(s) 118 of the system 100. The DPU 122 may be a smart Network Interface Controller (NIC) or may be associated with a smart NIC. The system 100 may include one or more circuits provided in one or more processors or processing units and may include execution units as well. The processors may include one or more of a CPU, a graphics processing unit (GPU), or a DPU. However, the workload aware packet steering by offloading herein may be performed by a DPU 110 instead of a CPU(s) or CPU core(s) 118.

For example, the system 100 includes at least one processor, such as one of the processing sub-systems 110, that may be associated with a DPU 122. The DPU 122 may be adapted for network communications 108 (also referred to herein as communications) that may represent or that may be the workload at issue. The DPU 122 may be adapted for network communications 108 with other external device(s) 116 using a NIC driver 106. In one example, the NIC driver 106 may be part of or may be in a location within a host node or machine 120 (such as, having an association with a CPU 118 of the host node 120). The DPU 122 may be part of a Virtio standard, but the approaches herein may not be limited to the Virtio standard. The DPU 122 herein may include or be associated with a data path module 112 and a packet steering module 114. Further, an application may be in at least one of different virtual machines (VMs 1-N 102A-102N). However, it is also possible for the application to be one of different applications handled directly by an operating system (OS) network stack 104.

In at least one embodiment, an OS network stack 104 may include a collection of at least software to enable the various communication protocols that may be layered over each other. In one example, a communication protocol used with the system 100 herein may be a Transmission Control Protocol (TCP)-based connection. The OS network stack 104 herein can enable one or more applications, which may be each of the VMs 1-N 102A-102N or which may be independent applications, to communicate with physical network devices, such as a DPU 122. For example, the OS network stack 104 may invoke the NIC driver 106, which can communicate with the DPU 122 to transmit packets. The packets may be Ethernet packets, in one instance. Further, if the Virtio standard is applied in system 100, the Virtio driver or interface of each of the VMs 1-N 102A-102N may communicate through the NIC driver 106 to the DPU 122.

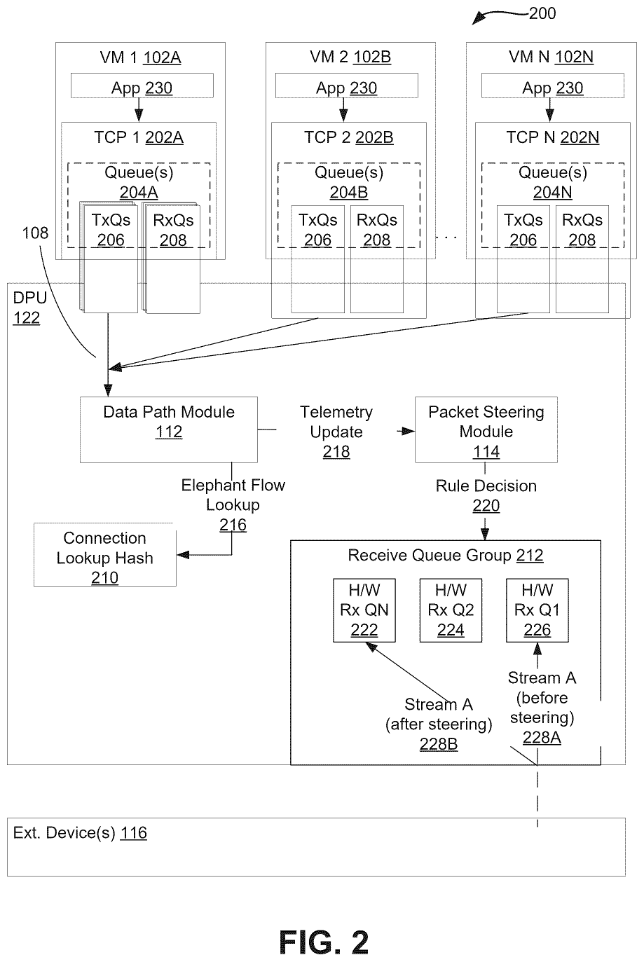

As illustrated, however, each of the applications (associated with each of the VMs 1-N 102A-102N, such as, in FIG. 2) may be handled by a different CPU core 1-3 124 or different CPU(s) or CPU core(s) 118 of the host node 120. Therefore, although illustrated as a singular CPU, there may be different CPUs for different VMs. In at least one embodiment, workload aware packet steering by offloading may ensure that incoming packets, usually handled by an RSS logic are, instead, handled by the packet steering module's associated logic. This is so that rules can be applied to the incoming packets to steer them to the same CPU or CPU core as the transmitting packets associated with an application. Further the steering may also provide load balancing for elephant flows as detailed further all throughout herein and as made apparent from the present description.

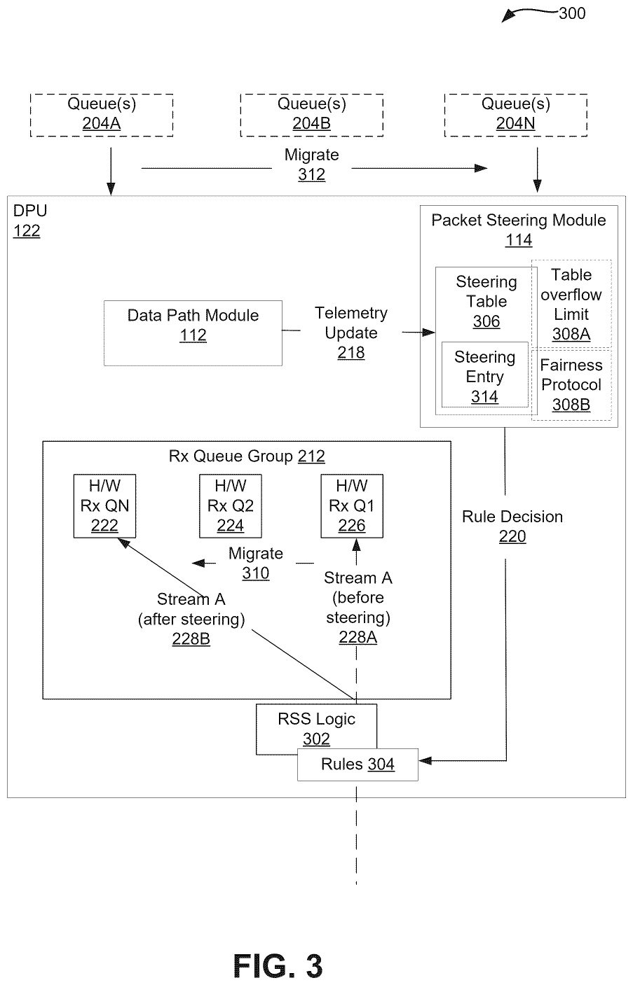

In at least one embodiment, RSS logic, which is described further with respect to at least FIG. 3 may be a hardware logic of a DPU 122 to handle multiple hardware (H/W) receive (Rx) queues (also referred to herein as a receive queue) Q1 226-Q1 226. In an example, a NIC driver 106 can communicate with a DPU 122 to establish the queues QN-Q1 222-226 for each CPU or CPU core, as part of a Rx queue group 212 (also referred to herein as a receive queue group). There may be a predetermined number of such receive queues QN-Q1 222-226 based in part on a capability of the DPU 122 and, in particular, the processing sub-system 110. The DPU 122 can then distribute the received packets among queue(s) 204A-204N of the communication protocols TCP 1-N 202A-202N using a respective hash generated from protocol headers associated with the received packets.

In an example, the hash allows the received packets to be maintained in a received order of a flow or stream. For example, the received order may be directed to a specific port so that intended packets are in the same receive queue among the maintained queue(s) 204A-204N of the OS network stack 104. In at least one embodiment, each of the OS network stack 104 maintains its own queue(s) 204A-204N, as if it is an independent virtual NIC, and which may include receive queues (RxQs) 208 that are different from the receive queues QN-Q1 222-226. Therefore, unless indicated otherwise, the reference to receive queues herein are to receive queues QN-Q1 222-226.

Further, an RSS logic can enable load balancing in the packet processing aspects of network communications, however, the workload aware packet steering herein uses rules to override the RSS logic at least for purposes of handling elephant flows. Further, the Linux® kernel may support receive packet steering (RPS) as a software implementation of the RSS logic. RPS applies to a receive queue and enables packets to be provided in a per-CPU queue process. Further, RPS may provide filters for hash generation or uses hashes from a NIC. Still further, receive flow steering (RFS) is able to direct packet flows to a CPU or CPU core that performs a specific application. For example, RFS can be application-specific to prevent migration to another CPU or CPU core. RFS uses a flow table with a key generated from an RPS hash that is paired with a CPU to prevent migration of flows. However, distinctly, from RFS and RPS, the workload aware packet steering herein provides rules that may include a priority setting therein to leave as-is or to override an RSS logic based in part on determination of elephant flows in a communication 108.

The data path module 112 can receive communications 108 associated with different Transmission Control Protocol (TCP)-based connections, also referred to herein as communication protocols. In one example, each of the VMs 1-N 102A-102N may open a different TCP connection or different applications may be associated with different TCP connections. Such different TCP connections may be referred to herein as different communication protocols (such as, TCP 1-N 202A-202N in FIG. 2). The data path module 112 can determine an elephant flow in the communications 108 based in part on a size indication associated with the communications. In one example, as used herein, an elephant flow is a large continuous flows associated with a single application, such as, a single VM. In one example, an elephant flow in a network link supporting a communication 108 may be larger than 1 GB/10 seconds. In one example, an elephant flow can consume a substantial portion of a network's bandwidth within a predefined period.

The size indication may be based in part on one or more of bytes per second of one flow associated with one of the different communication protocols, relative to other flows in the communications; a packet count relative to other flows in the communications; or a large send offload. For example, the size indication may be a predetermined bytes per second of one flow associated with one of the communication protocols, relative to other flows in the communications 108. Alternatively, a size indication may be a packet count relative to other flows in the communications 108. In yet another example, a size indication may be a large send offload indicated initially with one of the communications 108. The packet steering module 114 can receive information (such as, telemetry, as described further with respect to FIG. 2 herein). The telemetry may be associated with the elephant flow. The packet steering module 114 can enforce at least one rule to steer incoming packets for different receive queues associated with respective ones of the communication protocols.

A benefit realized by approaches herein may be the use of a data path module 112 to determine elephant flows in a DPU 122. A further benefit may be the use of a packet steering module 114 to determine a manner in which to enforce rules for packet steering before an RSS logic is applied. Such rules may be also based in part on overflow limits for at least one steering table that may be associated with the packet steering module or at least one fairness protocol to provide individual ones of the different communication protocols with a chance to be part of the elephant flow. These aspects performed by the DPU 122 take away from loading a CPU that may otherwise be required. These aspects performed by a DPU 122 also take away from the performance limitations by ensuring that incoming packets are directed to the appropriate queues for at least elephant flows. Further, these aspects performed by a DPU 122 also take away from work otherwise required to performed by thousands of VMs in a packet receiver path processing.

FIG. 2 is an illustration of further details of a system 200 for workload aware packet steering by offloading to a DPU, in at least one embodiment. The system 200 of FIG. 2 may be within the system 100 already described with respect to FIG. 1. However, the system 200 in FIG. 2 may be separate or in addition to aspects in the system 100 already described with respect to FIG. 1. In one example, the system 200 in FIG. 2 may include at least one processor, such as the DPU 122, that is provided for communications 108 to one or more external device(s) 116. The DPU 122 may include or be associated with a data path module 112 to receive the communications 108 associated with different communication protocols TCP 1-N 202A-202N, which may represent different open connections operating concurrently for different applications 230 that can invoke a respect one of the different communication protocols TCP 1-N 202A-202N. For example, different VMs 1-N 102A-102N may be associated with different open connections or the different communication protocols TCP 1-N 202A-202N.

Further, each of the different communication protocols TCP 1-N 202A-202N may be associated with a different queue(s) 204A-204N. Each of such different queue(s) 204A-204N may be associated with a respective one or more transmit queues (TxQs) 206 and one or more receive queues (RxQs) 208. Although all the communications 108 are illustrated as passing through the data path module 112, the data path module 112 may be only provided for monitoring the communications 108 and not necessarily for processing or handling the communications 108 in a way other than to enable workload aware packet steering herein.

For example, the data path module 112 can determine an elephant flow in the communications 108 by performing an elephant flow lookup 216 of a connection lookup hash 210, in at least one example. Further, the connection lookup hash 210 may include a size indication associated with the communications 108. While the communications 108 is generally indicated across different VMs 1-N 102A-102N, the elephant flow may be from only select ones of the different VMs 1-N 102A-102N.

The DPU 122 can use its packet steering module 114 to receive information associated with the elephant flow from the data path module 112. Such information may be in the form of a telemetry update 218 associated with the elephant flow. The packet steering module 114 can enforce, by a rule decision 220, at least one rule to steer incoming packets for different receive queue QN 222, from an initial or intended receive queue Q1 226. Each of such receive queues QN-Q1 222-226 may be within the receive queue group 212 and but may be associated with respective ones of the different communication protocols TCP 1-N 202A-202N.

As such, packet steering herein can change a stream A of the receive packets from a certain receive queue Q1 226, marked as before steering 228A, to a different receive queue QN 222, marked as after steering 228B, while keeping the stream A the same (no loss of receive packets, for instance). The stream A after steering 228B only reflects a different receive queue being used, following migration or steering of a stream, but can also reflect a different transmitter queue (such as, in reference numeral 312), as well, which is described further with respect to FIG. 3 herein. In at least one embodiment, the workload aware packet steering herein is an adaptive workload aware packet steering that offloads the packet steering aspect to a DPU 122 that is supported by a processor, such as, the DPU 122, as illustrated. The workload aware packet steering is adaptive because it can support packet steering for new elephant flows but can also remove assigned receive queues for inactive elephant flows.

FIG. 3 is an illustration of further system details 300 associated with rules to override receive side scaling (RSS) logic associated with workload aware packet steering by offloading to a DPU, in at least one embodiment. For example, the data path module 112 can detect an elephant flow of the workload in the communications 108, based in part on packet transmission within the DPU 122. The data path module 112 can then provide a telemetry update 218 to add or update a steering entry 314, in a steering table 306, for an elephant flow to be associated with a received packet of the communications 108.

The steering entry 314 may identify the flow by unique identifiers of the packet, such as, using a destination network address, a source network address, one or more ports, tuples, or other unique identifiers. The addition of a steering entry 314 to a steering table 306 may be performed to enable the packet steering module 114 to steer a stream or flow A (marked as before steering 228A) to an appropriate receive queue (such as, receive queue QN 222), which may be suited to the received packet (and its future packets). In at least one embodiment, the steering table 306 maintains active steering entries 314 using a hash table, a priority queue, or other suitable methods that are apparent upon reviewing this description. While inactive flows may be also maintained in such a steering table 306. For example, inactive flows may be associated with a least recently used (LRU) or a most recently used (MRU) logs of elements. These logs may allow the associated elephant flows to be maintained, but may only process them at a slower rate than any new elephant flows. However, the associated elephant flows may be processed actively, when needed, to support handling burst of elephant flows for multiple devices.

In one example, the packet steering module 114 enables migrating 310 of a flow or stream A (marked as before steering 228A) by steering receive packets from a first receive queue Q1 226 to a second receive queue QN 222 (marked as after steering 228B). Further, such migrating of the flow or stream A to a different receive queue may follow detection of an elephant flow and can also cause a further migration 312 of a first transmit queue (TxQ) 206 to a second transmit queue (TxQ) 206, where the first transmit queue (TxQ) 206 was previously associated with one of the communication protocols TCP 1-N 202A-202N but not as belonging to an elephant flow. Therefore, based in part on determining an elephant flow in a communication 108, a stream or flow (such as stream A, marked as before steering 228A, can be migrated 310, 312 from a first transmit queue and a first receive queue of a first one of the communication protocols to a second transmit queue and a second receive queue of a second one of the communication protocols, where the change to only the receive queue is illustratively marked as after steering 228B.

Further, the data path module 112 can monitor for an inactive elephant flow and can also remove or cause removal of a steering entry 314 that may be in a steering table 306 of the packet steering module 114. The addition or removal of a steering entry 314 can be performed for a scale of one to thousands of network devices and can be performed for thousands of transmit and receive queues at any given time. Further, the packet steering described herein can limit a number of steering entries resources per a network device's capability. This may be done to avoid resource exhaustion on the DPU 122 by a non-trusted VM, for instance, where the non-trusted VM fakes an elephant flow traffic with random source and destination port pairs to seek entry into the steering table. This may represent a parameter associated with a table overflow limit 308A established for the steering tables of the packet steering module. In one example, a table overflow limit 308A may be based in part on a size of a buffer available to the steering table 306. Therefore, this parameter may be implicitly applied based in part on a software allotment or a hardware limitation of the steering table 306.

In at least one embodiment, detection or monitoring for an increase in a flow that may result in an elephant flow (or a burst associated with an elephant flow) is also possible to avoid resource exhaustion on the DPU 122. In one instance, a combination of a data plane engine providing the data path module 112 and the packet steering module 114 can be made to work in tandem with a control plane engine of multiple CPUs or multiple CPU cores to distribute tasks of an elephant flow detection and flow steering or a control operation on these different types of engines. The elephant flow detection and measurement, by the data path module 112, may be performed based in part on taking a hint from a size indication or making an observation of a size indication. The size indication, in one example, may be a large send offload (LSO) operation initiated by the NIC driver 106. In other examples, the size indication may be a measure of number of packets and/or number of bytes per second associated with a part of or all communications 108.

Further, the size indication may be a measure of a flow with respect to or relative to other flows on the same communications 108 or across all the open connections or external device(s) 116. A relative measure may indicate that even if the flow is an LSO but not yet monitored as an elephant flow, an elephant flow may be determined for the LSO based in part on relative measure of bytes/sec or packets/seconds. For example, if the relative measure is low, even for an LSO, the flow may not be indicated as an elephant flow and such a flow may not be added as a steering entry into a steering table for the packet steering module 114.

In addition, if such a relative measure is low, an associated flow may be measured multiple times (such as, in different periods). This approach checks if an improvement in a performance of the flow occurs that may require the flow to be entered as an elephant flow into the steering table if the steering table can accommodate this. For example, the packet steering module 114 can enforce at least one of provided rule 304, through a rule decision 220, to steer incoming packets based in part on one or more of a first parameter associated with table overflow limit 308A for a steering table 306. In one example, the rule decision may be an override to the RSS logic 302. For example, when the steering table 306 is full, new flows may be detected and the data path module 112 may recognize this and may enable appropriate signals to be generated to monitor inactive flows more aggressively. This monitoring may be to remove inactive or previous elephant flows from the steering table 306.

The workload aware packet steering herein may be also influenced by other parameters, than the table overflow limit 308A. For example, a parameter associated with a fairness protocol 308B may be used to influence the workload aware packet steering. The fairness protocol 308B of the packet steering module 114 can provide individual ones of the communication protocols TCP 1-N 202A-202N with a chance to be part of an elephant flow. All such parameters of the packet steering module 114 ensure that, when an elephant flow is determined, the RSS logic 302 may not be applied to a packet of a stream A associated with an elephant flow. Then, the stream A that may be previous performed by a first receive queue Q1 226 (marked as before steering 228A) may be migrated. Then, based in part on the rule decision 220, incorporating the parameters to provide a priority setting therein, a rules 304 part of the receive queue group 212 can ensure override of the RSS logic 302. The override can cause stream A to be performed using a different receive queue QN 222 (marked as after steering 228B).

Therefore, as provided herein, at least one rule of the rules 304 feature is to steer the incoming packets to one of the different receive queues which is associated with one of the communication protocols or open connections. This steering is a migration that may be based in part on the elephant flow being associated with the one communication protocol or open connection of the available communication protocols or open connections. Further, the at least one rule of the rules 304 feature may be to steer the incoming packets to one of the different receive queues by an override to the RSS logic 302 that is associated with the one of the different receive queues. For example, before the RSS logic is reached, a priority setting of the rule decision 220 may cause the rule to take precedence to a packet of a flow determined to be an elephant flow. However, it is also possible for a null priority setting in the rule decision 220 to leave as unchanged an existing rule of the rules 304 feature that can cause steering of the incoming packets to the one of the different receive queues that were already set by a prior rule for an elephant flow. This allows elephant flows to continue till a change is caused, for instance. The change may be, in at least one example, a deactivation of an elephant flow based in part on an expiration of an inactive flow timer or the need for flow steering for higher priority elephant flows in a communication 108. In at least one embodiment, a hardware time within the system 100, 200 may be used for determining the inactive flow.

In one example, determining an elephant flow may be performed by, in part, by receiving an indication or a hint of an elephant flow that may be supplied by the NIC driver 106, when the NIC driver 106 is adapted with such capability. Therefore, both the DPU 122 and the NIC driver 106 may be adapted to work with an indication or hint of an elephant flow. In another example, determining an elephant flow may be performed by, in part, identifying the flow or stream to which a packet belongs and performing a count, a measure, or other monitoring of the packets that belong to a same flow. In one example, the same flow may be associated with a same source and destination network address, a same source and destination port number, or may share other such network identifiers. A hashing scheme may be used to evaluate and log a flow in a connection lookup hash 210, which can be sampled at a very low cost for determining the elephant flow.

However, such identification that received packets in a communication 108, are for a same flow or stream, may be a best effort basis to determine an elephant flow (and also to determine that a legitimate elephant flow) is associated with a TCP open connection. At least the use of a hash may be to ensure legitimacy of the flow and so that the flow is not a guest-induced denial of service attack on a steering table 306 of the packet steering module 114. A combination of ensuring that a flow is associated with a hash from the connection lookup hash 210 and of measuring monitored packets for statistics measures corresponding to an elephant flow, performed periodically and updated to monitor specific traffic from a communication 108, may be used to determine an elephant flow. The update may be provided via a telemetry update 218 to a packet steering module 114.

In at least one embodiment, monitoring of a flow, which is not yet present in a steering table 306, for an elephant flow because it is associated with a relatively high packet rate in a communication 108 may be useful to add elephant flows to the steering table 306, but such monitoring may be also used to proactively remove entries from the steering table 306. For example, the removal of entries may be an indication of a prior elephant flow that is now inactive and is an inactive entry. Further, such removal may be earlier than expiration of an inactive flow timer that may be provided with each flow in the steering table 306.

In at least one embodiment, the telemetry update 218 may include reporting details of an elephant flow that may be associated with telemetry, debug, or from network monitoring engines. In one example, the network monitoring engines may be able to analyze flows in the communications 108 and may be able to determine packet burst patterns. Further, the packet steering module 114 is able to independently track individual elephant flows of different network devices and is able to individually determine if larger ones of the elephant flows needs more attention than others. In one example, the packet steering module 114 is able to sort or order the steering table 306 to make such determinations.

In at least one embodiment, FIGS. 1-3 illustrate workload aware packet steering by the telemetry update 218 between a data path module 112 that performs monitoring of elephant flows and a packet steering module 114 that provides rule decisions 220. The packet steering module 114 acts on the telemetry update 218 to provide priority or other settings in the rule decisions 220. The priority or other settings can enable migration 310 of an elephant flow as part of the flow steering. In one example, the telemetry update 218 can cause additions to flow steering entries of a steering table 306. The additions may be specific to a certain flow associated with received packets at a first receive queue Q1 226. The addition can, however, cause a higher priority to be communicated via a rule decision 220 than an existing RSS logic 302 providing configuration in the DPU 122.

In a further example, the telemetry update 218 can cause removal of flow steering entries of a steering table 306. This may be a case when a flow is inactive for a stipulated period (such as the inactive flow timer) or when more urgent or larger elephant flows need to be added. In one example, the data path module 112 can monitor for inactive elephant flows. When an elephant flow is inactive for stipulated period, it can be marked as inactive and flow steering entry can be removed from the steering table 306. However, when a larger elephant flow than a current elephant flow is detected, and if the steering table 306 is not subject to the table overflow limit 308A, then a new flow may be added as a new flow steering entry. Further, monitoring for inactive flows may be performed at periodic intervals and may significantly affect a NIC caching sub-system. In one example, the caching sub-systems supporting the receive queue group 212 has thousands of flows. However, as some of the steering entries may be associated with flows that may be inactive, checking all of them may not be optimal. The inactive flow detection feature of the data path module 112 herein, however, can address this by only being required to monitor a predetermined number of flows that are substantially less than all the available steering entries to remove those predetermined number of flows from the steering table 306, when there is no pressing need to add more steering entries, in one example.

In at least one embodiment, the data path module 112 and the packet steering module 114 herein can also support scaling of adaptive workload detection to multiple thousands of devices by, in part, limiting a total number of steering entries in a steering table. For example, the limiting may be in a per device manner, which enables workload conserving. This approach allows one or more CPUs to utilize as many steering entries as possible on the device. However, when more CPUs open connections that may or may not be associated with elephant flows, there may be a requirement for the packet steering module to ensure equal distribution of a number of steering entries among the open connections. This may be to avoid starvation to other devices in the system.

Additionally, when the steering entries are nearly full or full and when new elephant flows are detected, inactive flow detection is proactively initiated to remove less-used steering entries before the period timer expires. Further, when multiple steering entries are added or to be added to a steering table, a check may be performed to verify such multiple steering entries as valid or not. For example, the multiple steering entries may be caused because of short bursts of traffic that a physical or virtual link can handle from an existing bandwidth or packet rate. However, an untrusted device may do this to fake an elephant flow. On detection, the untrusted device may be disabled for a short period of time to avoid any denial of service attack on the device.

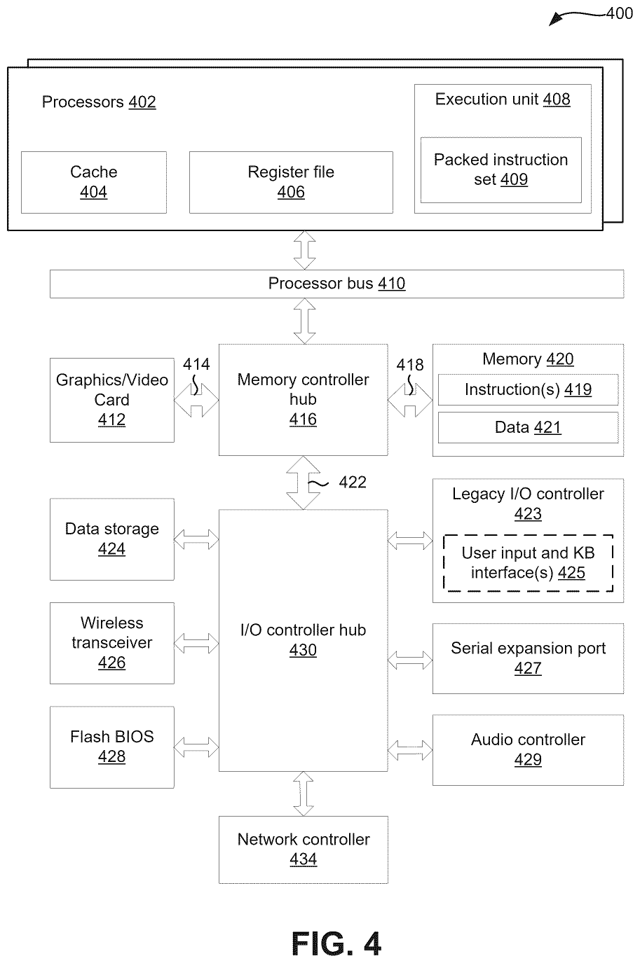

FIG. 4 illustrates computer and processor aspects 400 of a system for workload aware packet steering by offloading to a DPU, in at least one embodiment. For example, each of the illustrated processors 402 may include one or more processing or execution units 408 that can perform any or all of the aspects of the system 100 for workload aware packet steering by offloading from one circuit to other circuits in a computing environment. The system 100 may include the one or more processing or execution units 408 in one or more host machines in a computing environment.

The processing or execution units 408 may include multiple circuits to support the aspects described herein for one or more of the data path module 112 or the packet steering module 114. In at least one embodiment, the processors herein may include CPUs, GPUs, DPUs that may be associated with a multi-tenant environment to perform or be associated with one or more of the data path module 112 or the packet steering module 114 described herein. Further, the GPUs may be distinctly in distinct graphics/video cards 412, relative to a DPU (represented by a network controller 434) and a CPU represented by the processors 402 illustrated in FIG. 4. Therefore, even though described in the singular, the graphics/video card 412 may include multiple cards and may include multiple GPUs on each card and the network controller 434 may include multiple cards and may include multiple DPUs on each card.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-8 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processors 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processors 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414. In at least one embodiment, the graphics/video card 412 may be coupled to one or more of the processors 402 via a PCIe interconnect standard. Similarly, a network controller 424 may also be coupled to one or more of the processors 402 via a PCIe interconnect standard.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processors 402. Examples may include, without limitation, an audio controller 429, a firmware hub (“flash BIOS”) 428, a wireless transceiver 426, a data storage 424, a legacy I/O controller 423 containing user input and keyboard interface(s) 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

Therefore, the at least one execution unit 408 may be one or more circuits of at least one processor 402 and can include or be associated with a data path module and a packet steering module. The data path module of the one or more circuits can receive communications associated with different communication protocols and can determine an elephant flow in the communications. The one or more circuits may determine the elephant flow based in part on a size indication associated with the communications, which may be provided in the communications or may be determined from monitoring the communications using a connection lookup hash. The packet steering module can receive information associated with the elephant flow from the data path module. Such information may be telemetry updates indicating a new elephant flow or a change in an elephant flow of one of the communication protocols. The packet steering module can enforce at least one rule to steer incoming packets for different receive queues associated with respective ones of the communication protocols.

The one or more circuits may further include at least one processing sub-system of a Virtio standard DPU. In one example, the Virtio standard DPU may be used to create and deploy a physical or virtual NIC. Further, the size indication may be based in part on one or more of bytes per second of one flow associated with at least one of the communication protocols, relative to other flows in the communications; a packet count relative to other flows in the communications; or a large send offload indicated or determined from the communications. Still further, the at least one rule can steer the incoming packets to one of the different receive queues which is associated with one of the different communication protocols, from an initial communication protocol, based in part on the elephant flow being associated with the initial communication protocol. This may be done to ensure that available resources are used and dedicated to the elephant flow, once it is determined for a flow that is part of communications received in the NIC, for instance.

The one or more circuits can also enable the at least one rule to steer the incoming packets to one of the different receive queues by an override to an RSS logic associated with the one of the different receive queues. This may be performed using a rule decision have a priority setting from the packet steering module. However, the priority setting may be also provided to leave as unchanged an existing rule to steer the incoming packets to the one of the different receive queues. The unchanged existing rule may be associated with the RSS logic and is not a priority setting change to override the RSS logic, for instance.

In one example, the packet steering module can enforce the at least one rule to steer the incoming packets based in part on a one or more of a first parameter associated with at least one overflow limit for a steering table of the packet steering module. However, the packet steering module may also use a second parameter associated with a fairness protocol to provide individual ones of the different communication protocols with a chance to be part of an elephant flow. The elephant flow can be migrated, as part of the steering for the incoming packets, from a first transmit queue and a first receive queue of a first one of the communication protocols to a second transmit queue and a second receive queue of a second one of the communication protocols.

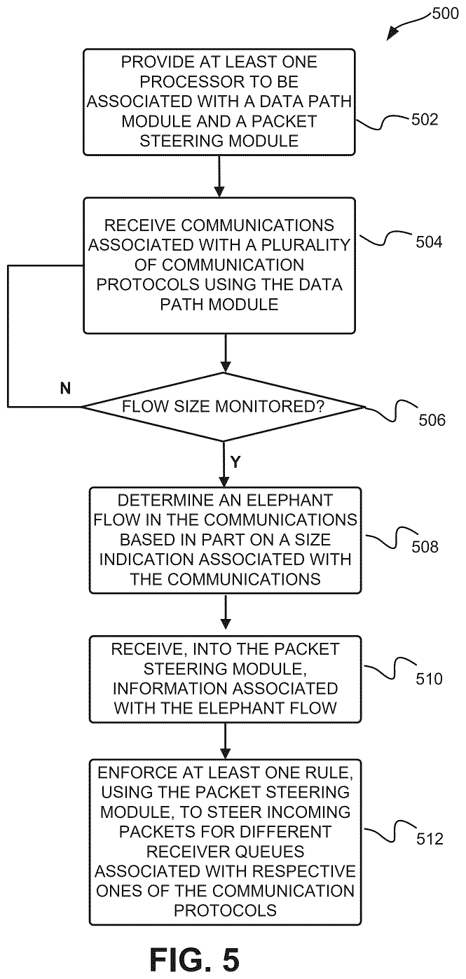

FIG. 5 illustrates a process flow or method 500 for a system for workload aware packet steering by offloading to a DPU, in at least one embodiment. The method 500 may include providing 502 at least one processor to include or be associated with a data path module and a packet steering module. The method 500 may further include receiving 504 communications associated with a plurality of communication protocols using the data path module. The method 500 may include verifying or determining 506 that the data path module is monitoring the communications of step 504. In one example, a NIC driver and the NIC may communicate capabilities of the NIC to enable the NIC driver to provide flow size indications in the communications. Such a feature may be part of the verifying or determining 506 step.

The method 500 may also include determining 508 an elephant flow in the communications based in part on a size indication associated with the communications. The monitoring may be for the communications and may be to enable a determination of an elephant flow by statistical measures that can be used for a size indication in the data path module. However, the monitoring may be for a size indication provided from the NIC driver or elsewhere and that is associated with at least one of the communication protocols from a CPU or CPU core. The method 500 may include receiving 510, into the packet steering module, information associated with the elephant flow. This may be performed by the data path module providing a telemetry update to the packet steering module. The method 500 may include enforcing 512 at least one rule, using the packet steering module, to steer incoming packets for different receive queues associated with respective ones of the communication protocols. This may be performed by the rule decision providing a priority setting, for instance, to override the RSS logic that may be otherwise used to direct received or incoming packets.

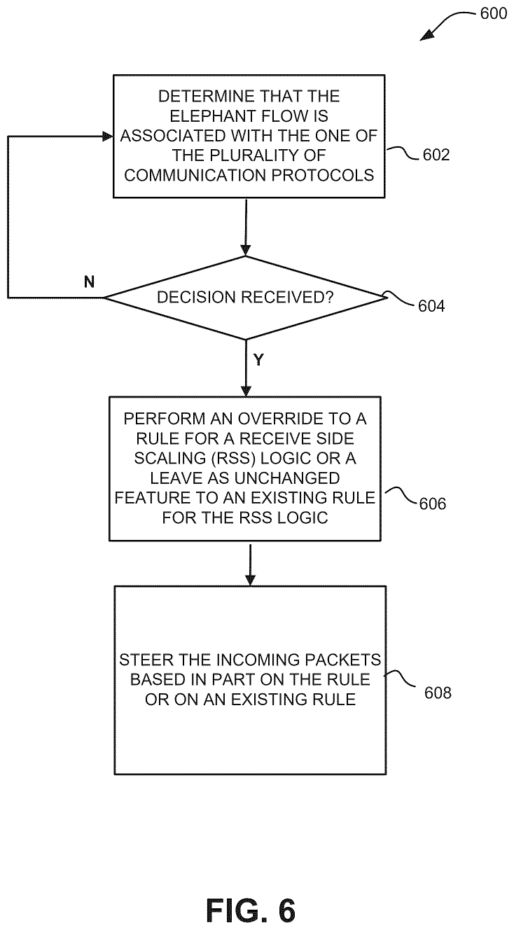

FIG. 6 illustrates yet another process flow or method 600 for a system for workload aware packet steering by offloading to a DPU, in at least one embodiment. The method 600 may be used in conjunction with the method 500 of FIG. 5, in at least one embodiment. The method 600 in FIG. 6 may include determining 602 that the elephant flow is associated with the one communication protocol (representing an open connection) of different communication protocols that may be in a communication from different CPUs or CPU cores. The method 600 may include verifying or determining 602 that a decision (such as the decision rule having a priority setting) is received in a rules feature of the NIC. The method 600 may include performing 606 an override to a rule for an RSS logic or a leave as unchanged feature to an existing rule for the RSS logic. The leave as unchanged feature may be a no action performed in the NIC for an existing rule as applied by the RSS logic for received or incoming packets, whereas the override may be performed by a rules feature of the NIC before the RSS logic is applied to the received or incoming packets. The rules feature may be a separate logic, such as a register setting that can override the RSS logic, in one example. The method 600 may include steering 608, as part of the step 512 in the method 500 of FIG. 5, the incoming packets based in part on the rule from the rules feature or the existing rule from the RSS logic.

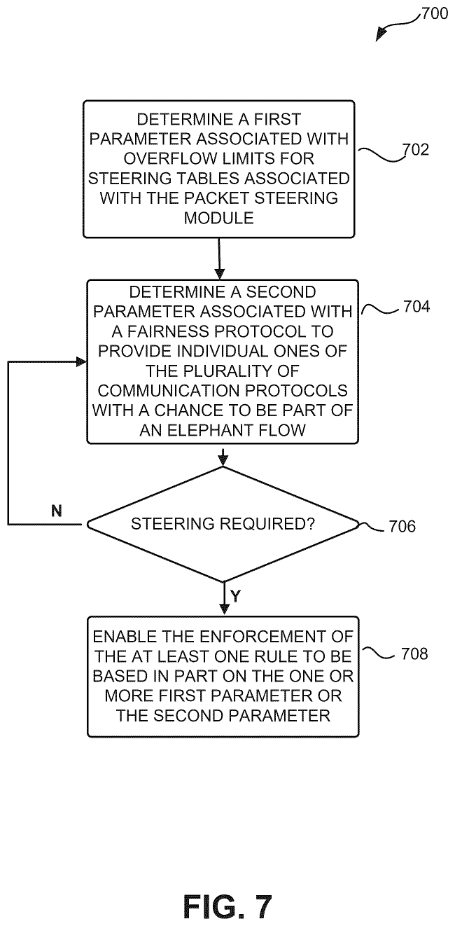

FIG. 7 illustrates a further process flow for a system for workload aware packet steering by offloading to a DPU, in at least one embodiment. The method 700 may be used in conjunction with one or more of the methods 500, 600 of FIGS. 5 and 6, in at least one embodiment. The method 700 in FIG. 7 may include determining 702 a first parameter associated with overflow limits for steering tables associated with the packet steering module. The method 700 may also include determining 704 a second parameter associated with a fairness protocol to provide individual ones of the multiple communication protocols with a chance to be part of an elephant flow. The method 700 may include verifying or determining 706 if steering is required for the incoming packets. This may be based in part on the monitoring performed by the data path module. The method 700 may include enabling 708 the enforcement of the at least one rule to be based in part on the one or more first parameter or the second parameter. In one example, this enabling 708 step may be in addition to using the information associated with the elephant flow in step 510 of the method 500 in FIG. 5.

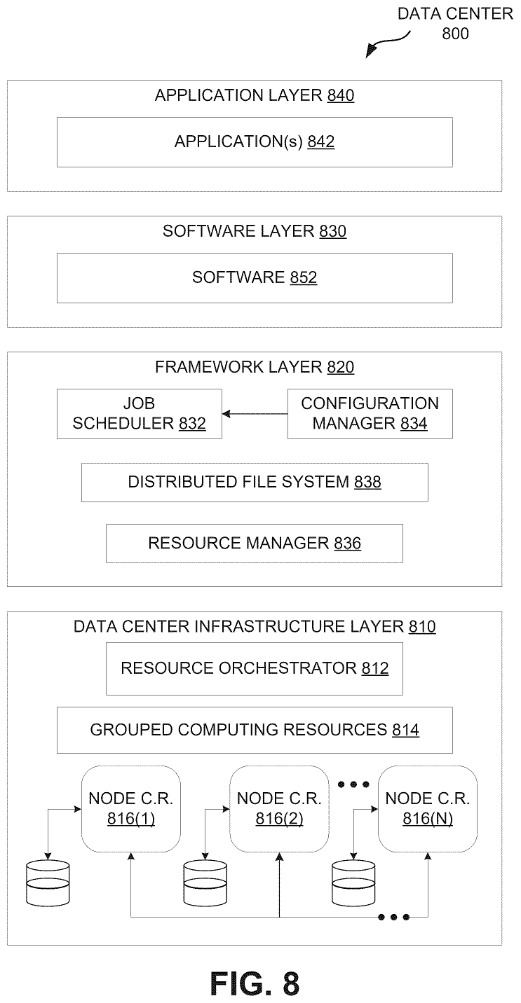

FIG. 8 illustrates an exemplary data center 800 and associated aspects to be used with a system for workload aware packet steering by offloading to a DPU, in accordance with at least one embodiment. In at least one embodiment, the data center 800 includes, without limitation, a data center infrastructure layer 810, a framework layer 820, a software layer 830 and an application layer 840, to perform aspects according to techniques described with respect to at least one or more of FIGS. 1-7 herein. For example, the exemplary data center 800 is able to handle elephant flows by at least one processor that may be a computing resource 816(1)-816(N) for handling network communications. Such a computing resource 816(1)-816(N) may be associated with a data path module to receive the communications which is associated with a plurality of communication protocols and to determine an elephant flow in the communications based in part on a size indication associated with the communications, Such a computing resource is 816(1)-816(N) further associated with a packet steering module to receive information associated with the elephant flow and to enforce at least one rule to steer incoming packets for different receive queues associated with respective ones of the plurality of communication protocols.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of DPUs, central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, VMs, power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes, without limitation, a job scheduler 832, a configuration manager 834, a resource manager 836 and a distributed file system 838. In at least one embodiment, framework layer 820 may include a framework to support software 852 of software layer 830 and/or one or more application(s) 842 of application layer 840. In at least one embodiment, software 852 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820, including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resources 814 at data center infrastructure layer 810. In at least one embodiment, resource manager 836 may coordinate with resource orchestrator 812 to manage these mapped or allocated computing resources.

In at least one embodiment, software 852 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. In at least one or more types of applications may include, without limitation, CUDA applications.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, associated aspects of the data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, DPUs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

FIG. 8 also sets forth, without limitation, exemplary computer-based systems that form associated aspects that can be used with the data center 800 to implement at least one embodiment. For example, the data center 800 includes a processing system, in accordance with at least one embodiment. In at least one embodiment, the processing system may include one or more processor(s) and one or more graphics processor(s), and may be a single processor desktop system, a multiprocessor workstation system, or a server system having a large number of processor(s) or processor core(s). In at least one embodiment, the processing system is a processing platform incorporated within a system-on-a-chip (“SoC”) integrated circuit for use in mobile, handheld, or embedded devices.

In at least one embodiment, the processing system can include, or be incorporated within a server-based gaming platform, a game console, a media console, a mobile gaming console, a handheld game console, or an online game console. In at least one embodiment, the processing system is a mobile phone, smart phone, tablet computing device or mobile Internet device. In at least one embodiment, the processing system can also include, coupled with, or be integrated within a wearable device, such as a smart watch wearable device, smart eyewear device, augmented reality device, or virtual reality device. In at least one embodiment, the processing system is a television or set top box device having one or more processor(s) and a graphical interface generated by one or more graphics processor(s).

In at least one embodiment, the one or more processor(s) each include one or more processor core(s) to process instructions which, when executed, perform operations for system and user software. In at least one embodiment, each of one or more processor core(s) is configured to process a specific instruction set. In at least one embodiment, an instruction set may facilitate Complex Instruction Set Computing (“CISC”), Reduced Instruction Set Computing (“RISC”), or computing via a Very Long Instruction Word (“VLIW”). In at least one embodiment, the processor core(s) may each process a different instruction set, which may include instructions to facilitate emulation of other instruction sets. In at least one embodiment, the processor core(s) may also include other processing devices, such as a digital signal processor (“DSP”).

In at least one embodiment, the processor(s) includes cache memory (“cache”). In at least one embodiment, processor(s) can have a single internal cache or multiple levels of internal cache. In at least one embodiment, cache memory is shared among various components of processor(s). In at least one embodiment, the processor(s) also uses an external cache (e.g., a Level 3 (“L3”) cache or Last Level Cache (“LLC”)) (not shown), which may be shared among processor core(s) using known cache coherency techniques. In at least one embodiment, the register file is additionally included in processor(s) which may include different types of registers for storing different types of data (e.g., integer registers, floating point registers, status registers, and an instruction pointer register). In at least one embodiment, the register file may include general-purpose registers or other registers.

In at least one embodiment, the one or more processor(s) are coupled with one or more interface bus(es) to transmit communication signals such as address, data, or control signals between processor(s) and other components in the processing system. In at least one embodiment interface bus(es) can be a processor bus, such as a version of a Direct Media Interface (“DMI”) bus. In at least one embodiment, the interface bus(es) is not limited to a DMI bus, and may include one or more of the Peripheral Component Interconnect buses (e.g., “PCI,” PCI Express (“PCIe”)), memory buses, or other types of interface buses. In at least one embodiment, the processor(s) include an integrated memory controller and a platform controller hub. In at least one embodiment, memory controller facilitates communication between a memory device and other components of the processing system, while a platform controller hub (“PCH”) provides connections to Input/Output (“I/O”) devices via a local I/O bus.

In at least one embodiment, the memory device herein can be a dynamic random access memory (“DRAM”) device, a static random access memory (“SRAM”) device, flash memory device, phase-change memory device, or some other memory device having suitable performance to serve as processor memory. In at least one embodiment, the memory device can operate as system memory for the processing system, to store data and instructions for use when one or more processor(s) executes an application or process. In at least one embodiment, the memory controller also couples with an optional external graphics processor, which may communicate with one or more graphics processor(s) in processor(s) to perform graphics and media operations. In at least one embodiment, a display device can connect to the processor(s). In at least one embodiment the display device can include one or more of an internal display device, as in a mobile electronic device or a laptop device or an external display device attached via a display interface (e.g., DisplayPort, etc.). In at least one embodiment, the display device can include a head mounted display (“HMD”) such as a stereoscopic display device for use in virtual reality (“VR”) applications or augmented reality (“AR”) applications.

In at least one embodiment, a platform controller hub enables peripherals to connect to the memory device and the processor(s) via a high-speed I/O bus. In at least one embodiment, the I/O peripherals include, but are not limited to, an audio controller, a network controller, a firmware interface, a wireless transceiver, touch sensors, a data storage device (e.g., hard disk drive, flash memory, etc.). In at least one embodiment, a data storage device can connect via a storage interface (e.g., SATA) or via a peripheral bus, such as PCI, or PCIe. In at least one embodiment, touch sensors can include touch screen sensors, pressure sensors, or fingerprint sensors. In at least one embodiment, a wireless transceiver can be a Wi-Fi transceiver, a Bluetooth transceiver, or a mobile network transceiver such as a 3G, 4G, or Long Term Evolution (“LTE”) transceiver. In at least one embodiment, firmware interface enables communication with system firmware, and can be, for example, a unified extensible firmware interface (“UEFI”). In at least one embodiment, a network controller can enable a network connection to a wired network. In at least one embodiment, a high-performance network controller couples with interface bus(es). In at least one embodiment, an audio controller is a multi-channel high definition audio controller. In at least one embodiment, the processing system includes an optional legacy I/O controller for coupling legacy (e.g., Personal System 2 (“PS/2”)) devices to processing system. In at least one embodiment, a platform controller hub can also connect to one or more Universal Serial Bus (“USB”) controller(s) connect input devices, such as a keyboard and mouse combinations, a camera, or other USB input devices.

In at least one embodiment, an instance of memory controller and a platform controller hub may be integrated into a discreet external graphics processor, such as external graphics processor. In at least one embodiment, a platform controller hub and/or a memory controller may be external to one or more processor(s). For example, in at least one embodiment, the processing system can include an external memory controller and a platform controller hub, which may be configured as a memory controller hub and a peripheral controller hub within a system chipset that is in communication with processor(s). In at least one embodiment, the system herein is an electronic device that utilizes a processor. In at least one embodiment, the system herein may be, for example and without limitation, a notebook, a tower server, a rack server, a blade server, a laptop, a desktop, a tablet, a mobile device, a phone, an embedded computer, or any other suitable electronic device.

In at least one embodiment, the system herein may include, without limitation, processor communicatively coupled to any suitable number or kind of components, peripherals, modules, or devices. In at least one embodiment, a processor herein is coupled using a bus or interface, such as an I2C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, the FIGS. herein illustrate a system which includes interconnected hardware devices or “chips.” In at least one embodiment, the FIGS. herein may illustrate an exemplary SoC. In at least one embodiment, devices illustrated herein may be interconnected with proprietary interconnects, standardized interconnects (e.g., PCIe) or some combination thereof. In at least one embodiment, one or more components of the FIGS. herein are interconnected using CXL interconnects.

In at least one embodiment, the FIGS. herein may include a display, a touch screen, a touch pad, a Near Field Communications unit (“NFC”), a sensor hub, a thermal sensor, an Express Chipset (“EC”), a Trusted Platform Module (“TPM”), BIOS/firmware/flash memory (“BIOS, FW Flash”), a DSP, a Solid State Disk (“SSD”) or Hard Disk Drive (“HDD”), a wireless local area network unit (“WLAN”), a Bluetooth unit, a Wireless Wide Area Network unit (“WWAN”), a Global Positioning System (“GPS”), a camera (“USB 3.0 camera”) such as a USB 3.0 camera, or a Low Power Double Data Rate (“LPDDR”) memory unit (“LPDDR3”) implemented in, for example, LPDDR3 standard. These components may each be implemented in any suitable manner.

In at least one embodiment, other components may be communicatively coupled to the processor herein through components discussed above. In at least one embodiment, an accelerometer, an Ambient Light Sensor (“ALS”), a compass, and a gyroscope may be communicatively coupled to a sensor hub. In at least one embodiment, a thermal sensor, a fan, a keyboard, and a touch pad may be communicatively coupled to an EC. In at least one embodiment, a speakers, a headphones, and a microphone (“mic”) may be communicatively coupled to an audio unit (“audio codec and class d amp”), which may in turn be communicatively coupled to DSP. In at least one embodiment, an audio unit may include, for example and without limitation, an audio coder/decoder (“codec”) and a class D amplifier. In at least one embodiment, a SIM card (“SIM”) may be communicatively coupled to a WWAN unit. In at least one embodiment, components such as WLAN unit and Bluetooth unit, as well as WWAN unit may be implemented in a Next Generation Form Factor (“NGFF”).

In the following description, numerous specific details are set forth to provide a more thorough understanding of at least one embodiment. However, it will be apparent to one skilled in the art that the inventive concepts may be practiced without one or more of these specific details.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising at least one processor for network communications, the at least one processor associated with a data path module to receive the communications which is associated with a plurality of communication protocols and to determine an elephant flow in the communications based in part on a size indication associated with the communications, and the at least one processor further associated with a packet steering module to receive information associated with the elephant flow and to enforce at least one rule to steer incoming packets for different receive queues associated with respective ones of the plurality of communication protocols.

2. The system of claim 1, wherein the at least one processor is a processing sub-system of a Virtio standard data processing unit (DPU).

3. The system of claim 1, wherein the plurality of communication protocols are different Transmission Control Protocol (TCP)-based connections.

4. The system of claim 1, wherein individual ones of the plurality of communication protocols are associated with individual ones of different virtual machines (VMs).

5. The system of claim 1, wherein the at least one rule is to steer the incoming packets to one of the different receive queues which is associated with one of the plurality of communication protocols, based in part on the elephant flow being associated with the one of the plurality of communication protocols.

6. The system of claim 5, wherein the at least one rule is to steer the incoming packets to one of the different receive queues is performed by an override to a receive side scaling (RSS) logic associated with the one of the different receive queues or is to leave as unchanged an existing rule to steer the incoming packets to the one of the different receive queues.

7. The system of claim 1, wherein the size indication is based in part on one or more of bytes per second of one flow associated with one of the plurality of communication protocols, relative to other flows in the communications; a packet count relative to other flows in the communications; or a large send offload.

8. The system of claim 1, wherein the packet steering module is to enforce the at least one rule to steer the incoming packets based in part on one or more of a first parameter associated with at least one overflow limit for a steering table of the packet steering module or a second parameter associated with a fairness protocol to provide individual ones of the plurality of communication protocols with a chance to be part of an elephant flow.

9. The system of claim 1, wherein the elephant flow is to be migrated from a first transmit queue and a first receive queue of a first one of the communication protocols to a second transmit queue and a second receive queue of a second one of the communication protocols.

10. One or more circuits associated with a data path module and a packet steering module, the data path module to receive communications associated with a plurality of communication protocols and to determine an elephant flow in the communications based in part on a size indication associated with the communications, and the packet steering module to receive information associated with the elephant flow and to enforce at least one rule to steer incoming packets for different receive queues associated with respective ones of the communication protocols.

11. The one or more circuits of claim 10, wherein the data path module is further to indicate that the elephant flow is inactive for stipulated period to cause the elephant flow to be inactive by, at least in part, removal of a steering entry for the elephant flow from a steering table.

12. The one or more circuits of claim 10, wherein the at least one rule is to steer the incoming packets to one of the different receive queues which is associated with one of the plurality of communication protocols, based in part on the elephant flow being associated with the one of the plurality of communication protocols.

13. The one or more circuits of claim 12, wherein the at least one rule is to steer the incoming packets to one of the different receive queues is performed by an override to a receive side scaling (RSS) logic associated with the one of the different receive queues or is to leave as unchanged an existing rule to steer the incoming packets to the one of the different receive queues.

14. The one or more circuits of claim 10, wherein the size indication is based in part on one or more of bytes per second of one flow associated with one of the plurality of communication protocols, relative to other flows in the communications; a packet count relative to other flows in the communications; or a large send offload.

15. The one or more circuits of claim 10, wherein the packet steering module is to enforce the at least one rule to steer the incoming packets based in part on a one or more of a first parameter associated with at least one overflow limit for a steering table of the packet steering module or a second parameter associated with a fairness protocol to provide individual ones of the plurality of communication protocols with a chance to be part of an elephant flow.

16. The one or more circuits of claim 10, wherein the elephant flow is to be migrated, as part of the steering for the incoming packets, from a first transmit queue and a first receive queue of a first one of the communication protocols to a second transmit queue and a second receive queue of a second one of the communication protocols.

17. A method for network communications, the method comprising:
providing at least one processor to be associated with a data path module and a packet steering module;
receiving communications associated with a plurality of communication protocols using the data path module;
determining an elephant flow in the communications based in part on a size indication associated with the communications;
receiving, into the packet steering module, information associated with the elephant flow; and
enforcing at least one rule, using the packet steering module, to steer incoming packets for different receive queues associated with respective ones of the communication protocols.

18. The method of claim 17, further comprising:
determining that the elephant flow is associated with the one of the plurality of communication protocols; and
performing an override to a receive side scaling (RSS) logic, associated with one of the different receive queues, to steer the incoming packets to one of the different receive queues which is associated with one of the plurality of communication protocols.

19. The method of claim 17, further comprising:
determining that the elephant flow is associated with the one of the plurality of communication protocols; and
leaving, as unchanged, an existing rule to steer the incoming packets to the one of the different receive queues.

20. The method of claim 17, further comprising:
determining a first parameter associated with at least one overflow limit for a steering table of the packet steering module;
determining a second parameter associated with a fairness protocol to provide individual ones of the plurality of communication protocols with a chance to be part of an elephant flow; and
enabling the enforcement of the at least one rule to be based in part on the one or more first parameter or the second parameter.
